(19) United States
(12) Patent Application Publication
(10) Pub. No.: US 2021/0097789 A1
(43) Pub. Date: Apr. 1, 2021

(54) PACKAGE-RECEIVING DOOR

(71) Applicant: Lawrence Ruel EDMISTER, Lexington, KY (US)

(72) Inventor: Lawrence Ruel EDMISTER, Lexington, KY (US)

(21) Appl. No.: 16/584,217

(22) Filed: Sep. 26, 2019

(51) Int. Cl. G07C 9/00

(52) U.S. Cl. CPC G07C 9/00126; G07C 9/00896; G07C 9/0069

(57) ABSTRACT

A package receiving door including a first door body including a major plane, an exterior side, an interior side, and a package door frame positioned around an opening within the first door body; a second door body in hingeable connection with the package door frame, the second door body receivable into the opening when the second door body is in a closed position, wherein a major plane of the second door body is substantially in the same plane as the major plane of the first door body when the second door body is in the closed position; a handle including a tenon positioned to engaged the second door body mortise when the second door body is in a closed position; wherein the handle is configured to disengage the tenon from the mortise of the second door body.

### FIELD OF THE INVENTION

The present invention relates generally to secure package delivery.

### BACKGROUND

Packages are currently delivered to residences and typically left on the porch or outside the front exterior door. Because these packages are unsecured, many packages are stolen. In fact, thefts are so common that the thieves have been deemed “porch pirates.”

### SUMMARY

Aspects of the present invention relate to a door, comprising a first door body comprising a major plane, an exterior side, an interior side, and a package door frame positioned around an opening within the first door body; a second door body in hingeable connection with the package door frame, the second door body receivable into the opening when the second door body is in a closed position, wherein a major plane of the second door body is substantially in the same plane as the major plane of the first door body when the second door body is in the closed position; a handle comprising a tenon positioned to engaged the second door body mortise when the second door body is in a closed position; wherein the handle is configured to disengage the tenon from the mortise of the second door body.

Additional aspects of the invention relate to a method of securely receiving packages, comprising: receiving a first access code; storing the first access code in a memory of a door lock comprising a microprocessor comprising the memory and a receiving door tenon biased to a closed position for engagement of a mortise of a package receiving door positioned in an exterior door; receiving a first attempt code through a keypad in electrical communication with the microprocessor; comparing the first attempt code to the first access code; when the first attempt code matches the first access code, setting the lock state of the handle to unlocked; when the unlocked handle is turned, disengaging a tenon to allow a receiving door to provide access to a receiving bag; receiving a package into the receiving bag connected with the frame of the receiving door.

Further aspects of the invention relate to a door lock for independently regulating access to a residence and a receiving bag of a residence, the door lock comprising: a handle connected with a first tenon and a second tenon; the first tenon disposed in a first direction comprising a closed position when extended and an open position when withdrawn; the second tenon disposed in a second direction comprising a closed position when extended and an open position when withdrawn; a keypad in electrical communication with a microprocessor comprising a memory, the microprocessor configured to store a first access code and a second access code; wherein the handle is mechanically engageable to move the first tenon from the closed position to the open position when an attempt code matches the stored first access code, and wherein the handle is mechanically engageable to move the second tenon from the closed position to the open position when an attempt code matches the stored second access code.

### BRIEF DESCRIPTION OF THE DRAWINGS

Various aspects of the present invention are illustrated by way of example, and not by way of limitation, in the accompanying drawings.

FIG. 1 illustrates a door in accordance with the principles of the present invention.

FIG. 2 depicts a door, such as an exterior residential door, comprising a package door in accordance with the principles of the present invention.

FIG. 3 depicts an interior view of the door comprising the package door in accordance with the principles of the present invention.

FIG. 4 depicts the package door of FIG. 2 having received a package in the receiving bag in accordance with the principles of the present invention.

FIG. 5 depicts the package door of FIG. 2 having received several packages such that the receiving bag is in the fully extended position and with an opening mechanism in an open position for removal of the packages in accordance with the principles of the present invention.

FIG. 6 depicts the receiving bag of FIG. 4 in accordance with the principles of the present invention.

FIG. 7 depict the package door without attachment to the door body in accordance with the principles of the present invention.

FIG. 8 depicts a block-level diagram of a microprocessor of the package door of FIG. 2 in accordance with the principles of the present invention.

FIG. 9 depicts a block-level diagram of a method of opening the package door of FIG. 2 in accordance with the principles of the present invention.

FIG. 10 depicts a diagram of an alternate embodiment of the package door lock according to the principles of the present invention.

FIG. 11 depicts a block-level diagram of the construction of the package door into an industry standard door in accordance with the principles of the present invention.

FIG. 12 illustrates a block diagram of a method of installation of the package door into a standard door in accordance with the principles of the present invention.

### DETAILED DESCRIPTION OF THE PREFERRED EMBODIMENTS

The present invention relates generally to secure package delivery, and more particularly, to structures and methods for secure unattended receipt of delivered packages into a residence upon delivery.

Packages are currently delivered to residences and typically left on the porch or outside the front exterior door. Because these packages are unsecured, many packages are stolen. In fact, thefts are so common that the thieves have been deemed “porch pirates.”

Some residents have installed video cameras to record occurrences on their respective front porches. However, these video cameras may only capture images of the thief with the possibility of capturing the thief after-the-fact. On the other hand, embodiments of the present invention may prevent the theft beforehand.

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

As used herein, “near” means within ⅓ of the area of the container unit. For example, if a portion of the male connector is described as “near” the pivot bolt, this portion is within ⅓ of the shank length from the pivot bolt (e.g. the shank is the container unit that touches both “near” structures).

As used herein, “about” means within plus or minus one at the last reported digit. For example, about 1.00 means 1.00±0.01 unit. In fractions, about 1 1/16 units means from 1 0/16 units to 1 2/16 units. In percentages, about 11% means 10% to 12%.

As used herein, “Id” refers to a unique identifier corresponding to a real-world counterpart. For example, patient Id refers to a unique identifier corresponding to a patient. The unique identifier may be used to associate other data to the counterpart, such as the patient, by association of the Id. Furthermore, the Id may be used in electronic storage, such as a unique key to distinguish patients and patient-related information in a database.

With respect to the present application, “around” used in conjunction with a numeral measurement means within plus or minus one unit. For example, around 50% means 49%-51%. For example, around 11.01 units means 10.01-12.01.

With respect to the present application “and” and “or” shall be construed as conjunctively or disjunctively, whichever provides the broadest disclosure in each instance of the use of “and” or “or.”

“Substantially,” as used herein with reference to a shape, means within manufacturing tolerance of manufacturing the referenced shape as well as any other shape falling within the doctrine of equivalents for the referenced shape.

Any directional words, such as “top,” “bottom,” “up,” “down,” etc. used herein refer to the direction depicted in the figure described. If the described device is rotated, these directions remain indicative of the position described relative to the figure.

“Connected to,” as used herein, means a direct physical connection between structures without intervening structures. Examples include glue, nails, screws, fictional fit, etc.

“Connected with,” as used herein, means a physical connection between structures, with intervening structures.

“Bias,” as used herein, means a return to default position or shape of a structure. Bias may occur through springs, such as a hinge, doorknob, handle, or tenon. Bias may also occur through rigid flexibility of a material returning to original shape after deformation.

“Tenon,” as used herein is an extendable and/or withdrawable rigid projection, such as those used to lock or bolt a door in the locked state or to hold a door in the closed position until opened, such as a doorknob tenon. The mechanism of extension and/or withdrawal may be substantially similar to a latchbolt, a deadlatch, a doorknob, or anything comparable mechanism.

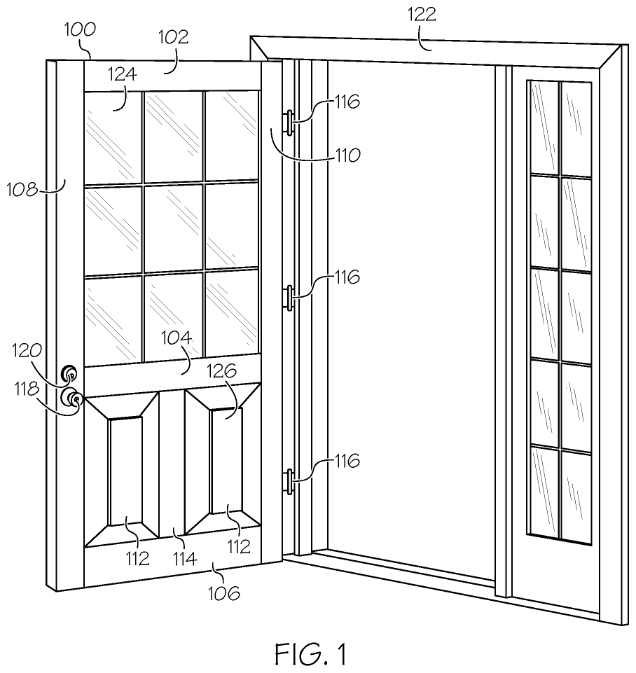

FIG. 1 illustrates a door 100 in accordance with the principles of the present invention. The door 100 may be a front door, such as those typically found on a residence. The door 100 may comprise a sturdy material, such as wood, glass, metal, etc., sufficient to reduce the occurrence of unauthorized entry when the door 100 is locked. The door 100 may be situated on hinges 116, such that the door 100 may be ajar for entry or closed for reduction of heat exchange between the ambient residential temperature and the outdoor atmosphere. The door 100 may further comprise a doorknob 118 and/or deadbolt 120. The deadbolt 120 may be lockable and unlockable by tumblers that can receive a matching key to switch between locked and unlocked states. When in a locked position, a deadbolt tenon of the deadbolt 120 may be in an extended position, such that the deadbolt tenon may be engaged with doorframe 122 when locked. The doorknob 118 may be lockable and unlockable by tumblers that can receive a matching key to switch between locked and unlocked states. However, the doorknob 118 may be turnable in the unlocked state to disengage a doorknob tenon of the doorknob 118. In the locked state, the doorknob 118 may not necessarily be turnable such that the doorknob tenon may not necessarily be disengaged. Alternatively, the doorknob 118 may be turnable but disengaged from mechanical communication from the doorknob tenon in the locked state such that turning the doorknob 118 may not necessarily withdraw the doorknob tenon.

The door 100 may comprise a top rail 102 spanning the top of the door 100 and frictionally fit between a lock stile 108 and a hinge style 110 of the door 100. A bottom rail 106 may frictionally fit with and span between the lock style 108 and the hinge style 100 at the bottom of the door 100. A lock rail 104 may be frictionally fit with and span between the lock stile 108 and the hinge style 110. The lock rail 104 may be positioned between the top rail 102 and the bottom rail 106. An upper panel 124 may be frictionally fit with the top rail 102, the lock rail 104, the hinge stile 110 and the lock stile 108.

A lower panel 126 may be frictionally fit with the lock rail 104 the bottom rail 106, the lock stile 108, and the hinge stile 110, which collectively may form a perimeter around the lower panel 126. The lower panel 126 may comprise one or more ornamentation panels 112 and/or one or more mullions 114. A typical residential entry door may have a height of about 203.2 cm (80 inches) and a width of about 91.44 cm (36 inches).

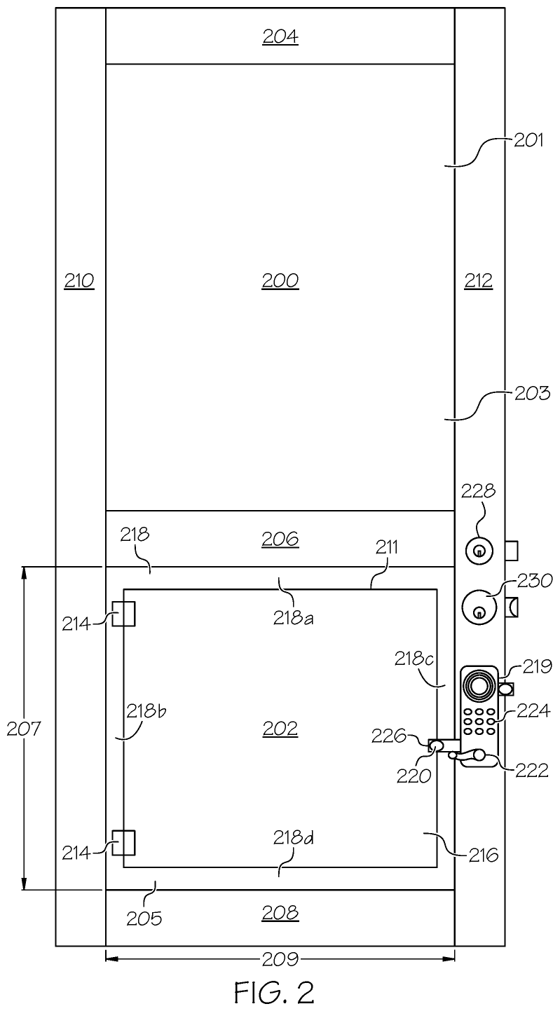

FIG. 2 depicts a door 200, such as an exterior residential door, comprising a package door 202 in accordance with the principles of the present invention. The door 200 may be similar in all respects to the door 100. The door 200 may comprise any material of the door 100. The door 200 may be in hingeable communication with a doorframe (not depicted), similar to the door 100. In some embodiments, the door 200 may be hingeably connected to the doorframe by screws setting hinges against the hinge stile 210 of the door body 201 and the doorframe. The door body 201 may be about 66.04 cm (26 inches) wide by about 78.74 cm (31 inches) in height.

The door 200 may comprise a top rail 204 frictionally fit between the hinge stile 210 and the lock stile 212 at a top of the door 200. The door 200 may comprise a lock rail 206 frictionally fit between the hinge stile 210 and the lock stile 212 and positioned between the top rail 204 and a bottom rail 208. The door 200 may comprise a bottom rail 208 frictionally fit between the hinge stile 210 and the lock stile 212 at the bottom of the door 200.

The door 200 may comprise a deadbolt 228 and a doorknob 230. The deadbolt 228 may comprise a thumbturn in communication with a deadbolt tenon. The deadbolt tenon may be extended beyond the door body 201 when turned in a first direction. The deadbolt tenon may be withdrawn into the door body 201 when turned in a second direction. In this manner, the deadbolt tenon may interact with a mortise of the doorframe 122 to lock and/or unlock the door 200. In some embodiments, deadbolt 228 may comprise deadbolt lock. For example, deadbolt lock may be lockable and unlockable when a key is turned in the deadbolt lock and when the key matches tumblers of the deadbolt lock. Such a locked state corresponds to the extended position of the deadbolt tenon. The counterpart unlocked state corresponds to the withdrawn position of the deadbolt tenon.

Doorknob 230 may comprise a handle, a doorknob lock, a doorknob tenon. The handle may be in communication with the doorknob tenon such that the doorknob tenon may be withdrawn into the door body 201 when the handle is turned. In some embodiments, turning the handle either direction withdraws doorknob tenon and the handle biases to center with the tenon extended. In this manner, the doorknob 230 may bias to hold the door 200 closed, yet easily openable. In some embodiments doorknob 230 may comprise a doorknob lock. The doorknob lock may be lockable and unlockable when a key is turned in the doorknob lock when the key matches tumblers of the doorknob lock. This unlocked state may correspond to the communication of the handle and the doorknob tenon as described above. The corresponding locked state may correspond to disengagement of the handle from the doorknob tenon or disabling the handle from turning.

The door 200 may comprise an upper panel 203 connected to the upper rail 204, the lock rail 206, the lock stile 212, and the hinge stile 210. The door 200 may comprise a lower panel 205 connected to the lock rail 206, the lock stile 212, the hinge stile 210, and the bottom rail 208. The door 200 may comprise the package door 202. In some embodiments, the lower panel 205 may be the package door 202.

The package door 202 may comprise a package door body 216, which may comprise a rectangular prism of sturdy material, such as any material of the door 200.

In some embodiments, the package door 202 may comprise a package door frame 218. In these embodiments, the package door frame 218 may be connected to package door hinges 214, such that the package door body 216 may be received into the package door frame 218. The package door frame 218 may comprise a frame top rail 218a, a frame hinge stile 218b, a frame lock stile 218c, and a frame bottom rail 218d. The frame top rail 218a may be connected to, or integrally formed with, the lock rail 206 and/or a portion of the lower panel of the door body 201. The frame hinge stile 218b may be connected to, or integrally formed with, the hinge style 210 and/or a portion of the lower panel of the door body 201. The frame lock stile 218c may be connected to, or integrally formed with, the lock style 212 and/or a portion of the lower panel of the door body 201. The frame bottom rail 218d may be connected to, or integrally formed with, the bottom rail 208 and/or a portion of the lower panel of the door body.

The package door frame 218 may comprise an exterior base width 209 and an exterior base height 207. The exterior base height 207 may span from the bottom rail 208 to the lock rail 206. The exterior base width 209 may span from the lock stile 212 to the hinge stile 210.

The package door 202 may be in hingeable communication with the door body 201. For example, hinges 214 may be connected to the package door body 216. The hinges 214 may also be connected to the door body 201. In some embodiments, the hingeable relationship may provide hingeable relationship in which the package door 202 may open outwardly on the exterior side of the door 100. For example, the hinges 214 may be placed vertically. Soss hinges may be used to allow full range of motion and full closing of the package door 202 such that the package door body 216 may be substantially flush with the door body 201. Furthermore, soss hinges may allow for opening the door body 201 toward the exterior of the door 200 without the hinges 214 being placed on the exterior of the door 200. In this manner, the soss hinges may allow for hiding the hinges 214 to prevent tampering.

The package door 202 may comprise a package door lock 219. The package door lock 219 may comprise a keypad 224, a package door handle 222 (e.g. a handle, lever handle, etc.), a package door tenon 220, and/or a processor (not depicted). The processor and the keypad 224 may be in electrical communication. The processor may comprise and/or may be in electrical communication with a memory. In this manner, the processor may receive an attempt code from the keypad, which may receive the code as input. The processor may compare the attempt code to an access code stored in the memory.

The frame lock rail 218c may comprise a hole in which a portion of the package door tenon 220 may be passed through, such that the package door tenon 220 may be received in a package door mortise 226 when the package door 202 is in the closed position. The package door mortise 226 may be reinforced, such as by a strike plate surrounding an opening of the mortise 226.

The package door tenon 220 may bias to the extended position such that the package door tenon 220 may engage package door mortise 226 to close the package door body 216. Furthermore, the package door lock 219 may bias to a locked state such that the package door 202 may automatically lock upon closing. When the package door lock 219 is in the lock state, the handle 222 may be disengaged from mechanical communication with the package door tenon 220, or alternatively, the handle 222 may not necessarily be turnable. In some embodiments, the package door tenon 220 may comprise a rounded edge such that the package door tenon 220 may be withdrawn sufficiently to close the package door 202 upon the package door tenon 220 hitting a strike plate at the mortise 226. In this manner, the package door 202 may be closed and locked automatically without necessarily requiring re-entry of the code or reengagement of the handle 222. In fact, the handle 222 may be disengaged upon opening the package door 202. Embodiments of the package door lock 219 may include a Honeywell Electronic Entry Deadbolt Lock Model #8712509, a Honeywell Electronic Entry Lever Door Lock Model #8734401, a Honeywell Electronic Entry Knob Door Lock Model #8732401, or the like.

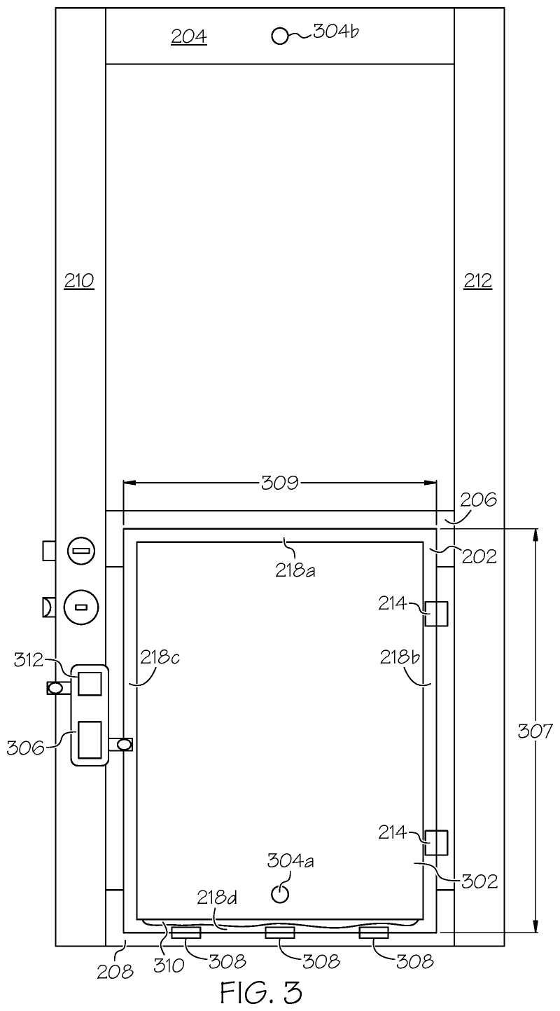

FIG. 3 depicts an interior view of the door 200 comprising the package door 202 in accordance with the principles of the present invention.

The package door frame 218 may extend further on the interior of the door 200 than the exterior of the door 200, in some embodiments. For example, embodiments include the package door top frame rail 218a position to cover the lock stile 206, or even a portion of the upper panel of the door 200.

The package door frame 218 may comprise an interior base height 307 and an interior base width 309. For example, the interior base height 307 and the interior base width 309 may be comprised of the attachment of the opening of the receiving bag 310 around the package door 202. Such attachment may be by glue, nails, screws, or any secure combination or alternative thereof. The interior base height 307 may be equal to or greater than the exterior base height 207. The interior base width 309 may be equal to or greater than the exterior based width 209. By way of example, the package door frame 218 may extend beyond the proximal edge of the lock rail 206 and/or the proximal edge of the bottom rail 208. In this manner, a receiving bag 310 can be around the opening 211 of the package door 202. More specifically, a perimeter of the receiving bag 310 may be attached to the package door frame 218 such that a perimeter of the opening 211 of the package door 202 is within the perimeter of attachment of the receiving bag 310. In some embodiments, the additional height of the interior base height 307 over exterior base height 207 and/or the additional width of the interior base width 309 over interior base width 209 may allow for the perimeter of the attachment of the receiving bag 310 to surround the perimeter of the opening 211 of the package door 202. Furthermore, this extra height at the lock rail 206 may allow for hanging a cover. The extra height at the bottom rail 208 may allow for attachment of receiving bag hinges 308 to the bottom rail 208. Alternatively, the receiving bag hinges 308 may be connected to the lower panel 205 (e.g. in embodiments wherein the frame 218 lies within the lower panel 205). In some embodiments, the receiving bag hinges 308 may be covered with a flap of material similar to that of the receiving bag 310.

The package door 202 may comprise a cover 302. By way of example, the cover 302 may at least partially conceal the package door 202, or any part thereof (e.g. the receiving bag 310), from an interior viewpoint when the package door 202 does not contain a package. The cover 302 may comprise a first attachment mechanism counterpart 304a, which may be secured to a second attachment mechanism counterpart 304b. In this manner, the cover 302 may be positioned to reveal the package door 202, or its bag, such as for removal of a contained package. Examples of a cover attachment mechanism comprising the first attachment mechanism counterpart 304a and the second attachment mechanism counterpart 304b can include a ring and pin, male and female snaps, hook and loop, or any other attachment mechanism for removable temporary attachment.

In some embodiments, the package door 202 may comprise a battery 306 and a microprocessor 312. More specifically, the package door lock 219 may comprise the battery 306 and the microprocessor 312. The battery 306 may be in electrical communication with and may provide power to the elements of the package door lock 219, such as the microprocessor 312 and/or the keypad 224.

The microprocessor 312 may store a lock status, such as in a memory. By way of example, the lock status may comprise a variable, such as a Boolean value. The lock status may correspond to the lock state of the package door 202. Therefore, a locked status may correspond to a locked state of the package door lock 219 and an unlocked status may correspond to an unlocked state of the package door lock 219.

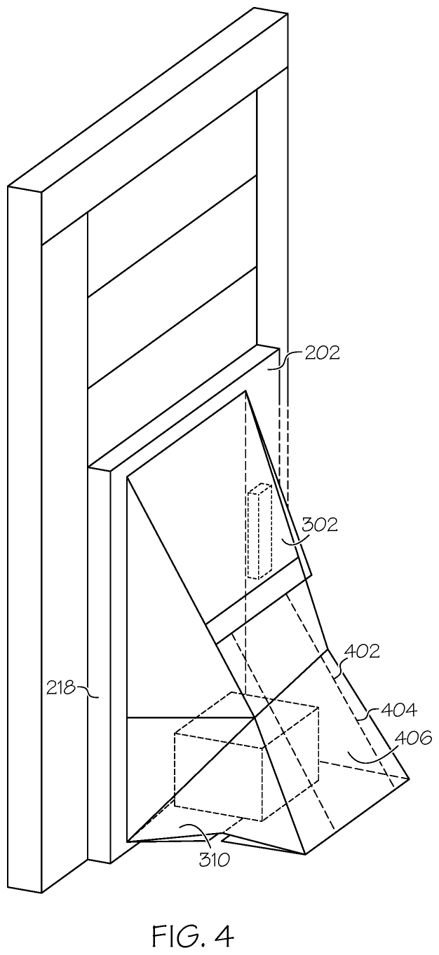

FIG. 4 depicts the package door 202 of FIG. 2 having received a package in the receiving bag 310 in accordance with the principles of the present invention. The receiving bag 310 may be in a semi-expanded state. The receiving bag 310 may be connected to the package door frame 218. In some embodiments, the receiving bag 310 may be connected to the door body 201 directly.

As is illustrated, the package may be received through the opening 211 of the package door 202 when the package door lock 219 is in the unlocked state and the door body 201 is opened. When the door body 201 closes, such as by spring-bias of the package door hinges 214, the package door lock 219 may re-engage the corresponding tenon and mortise and return to the locked state. In the manner, the package may be received from a delivery person from the exterior side of the door into the interior of the house without allowing access into the house.

In some embodiments, the resident could reopen the package door 202 from the exterior to get the package. However, many residents may prefer opening the receiving bag 310 directly from the interior of the residence. For example, the receiving bag 310 may comprise an opening mechanism 402. The opening mechanism 402 may comprise a zipper 404 and/or a receiving bag flap 406. In some embodiments, the zipper 404 may have a slider on the outside of the receiving bag 310 (e.g. interior side of the package door 202), such as for access from within the residence without providing access from the exterior of door 200 into the residence. The zipper 402 may at least partially surround an external material of the receiving bag 310. The surrounded material may comprise the receiving bag flap 406. The receiving bag flap 406 may be moved out of the way to remove the package from within the receiving bag 310.

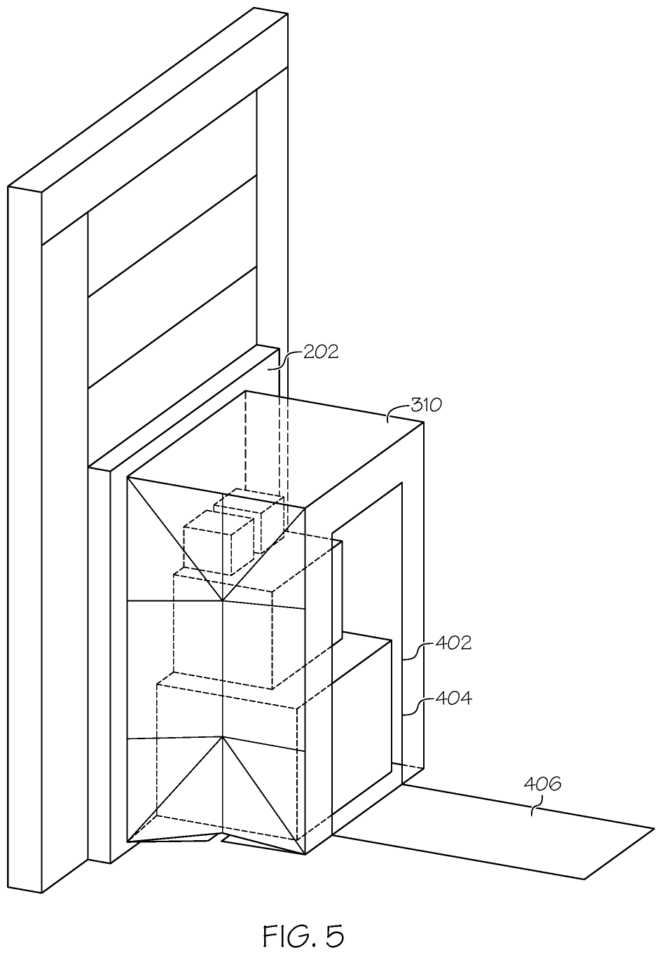

FIG. 5 depicts the package door 202 of FIG. 2 having received several packages such that the receiving bag 310 is in the fully extended position and with an opening mechanism 402 in an open position for removal of the packages in accordance with the principles of the present invention. The receiving bag 310 may be positioned in an expanded state.

By way of example, the opening mechanism 402 may comprise the zipper 404 may have three connected runs in the shape of a rectangle, such that flap 406 is formed in the connected material of the receiving bag 310. For example, the zipper runs may span two sides and a top, such that the bottom may be hinged. In other embodiments, one of the side or the top may be hinged.

In some embodiments, the cover 302 may comprise attachment 702 to the receiving bag 310. For example, the cover 302 may be sewn to the material of the receiving bag 310, such as the material surrounding top panel 602. The cover 302 may be sewn through top panel 602. Alternatively, the cover 302 may be sewn to the top of the receiving bag 310. In these embodiments, the cover 302 may support the receiving bag 310 such that raising the cover 302 may extend the receiving bag 310. Furthermore, attaching first attachment mechanism counterpart 304a to second attachment mechanism counterpart 304b may hold the receiving bag 310 in the extended position.

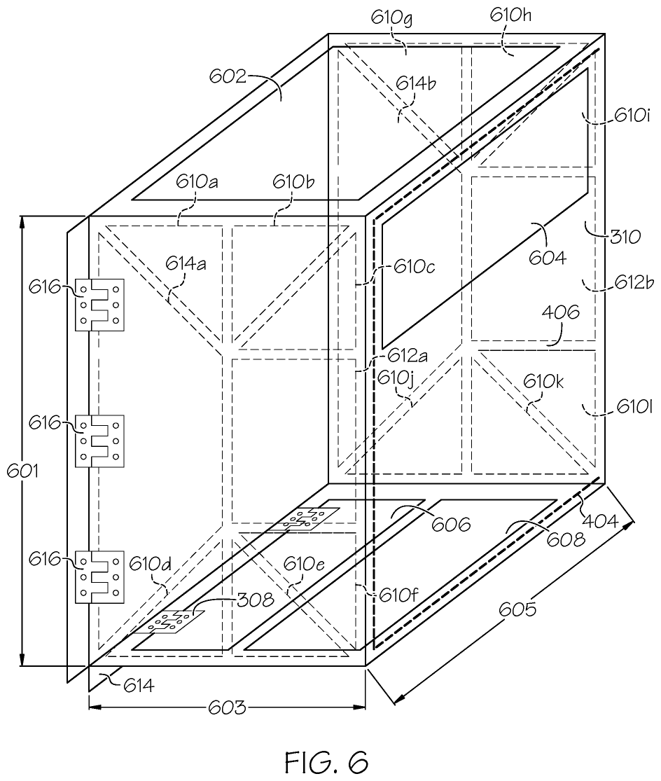

FIG. 6 depicts the receiving bag 310 of FIG. 4 in accordance with the principles of the present invention. The receiving bag 310 may generally comprise a fabric. In some embodiments, the fabric of the receiving bag 310 may be a cut-proof or cut-resistant fabric. By way of example, the receiving bag 310 may comprise one or more panels that may be sewn into the receiving bag 310. The panels may be rigid or semi-rigid, deformable yet biasing to flat. These panels may help the bag retain shape in the compressed position, fully extended position, and each step in between.

A top wall of the receiving bag 310 may comprise a top panel 602. The receiving flap 406 may comprise a receiving flap panel 604. A bottom wall of the receiving bag may comprise a first panel 606 and a second panel 608. The first panel 606 may be proximal the package door body 201 relative to the second panel 608. The first panel 606 may comprise wood or another rigid material. The first panel 606 may be attached to the frame 218 by hinges 308. The hinges 308 may bias such that first panel 606 may be rotated to a vertical position. In this manner, the receiving bag 310 may bias to folding to a compressed state. When a package is received into the receiving bag 310, the weight of the package may press the first panel 606 into a horizontal position that may be substantially in plane with the second panel 608. In this manner, the receiving bag 310 may be expanded to receive packages. Furthermore, the appearance of the expanded state may alert a resident that a package has been delivered. By way of example, the material between panels, such as between first panel 606 and second panel 608, may allow hingeable communication between panels that may assist in folding receiving bag 310 into the compressed state. Furthermore, each side wall of the receiving bag 310 may comprise corner panels 610a-6101 and height panels 612a-612b. Bottom flap 614 may comprise material of the receiving bag 310 positioned to cover the hinges 308.

The receiving bag 310 may comprise hinged side panels 614a and 614b. In some embodiments, hinged side panels 614a and 614b may comprise a rigid material, such as wood. Furthermore, the hinged side panels 614a and 614b may be connected to door body 201 and/or the door frame 218 by hinges 616. The hinges 616 may be spring-biased to a compressed position. In this manner the receiving bag 310 may bias to a compressed state unless the presence of a package holds the receiving bag 310 in the expanded state. The hinged side panels 614a and 614b may be trapezoid-shaped. However, embodiments include the receiving bag 310 comprising two corner panel similar to 610a-610l and on height panel similar to 612a-612b in place of each hinged side panel 614a and 614b. These alternate embodiments do not necessarily have hinges at the sides of the receiving bag 310.

The receiving bag 310 may comprise a height 601. In some embodiments, the height 601 may be about 91.44 cm (36.0 inches). The receiving bag 310 may comprise a depth 603. In some embodiments, the depth 603 may be about 45.72 cm (18.0 inches) in the expanded state. In the compressed state, the depth 603 of the receiving bag 310 may be about 2.54 cm (1.0 inch). In some embodiments, the receiving bag may comprise a width 605. The width 605 may be about 55.88 cm (22 inches).

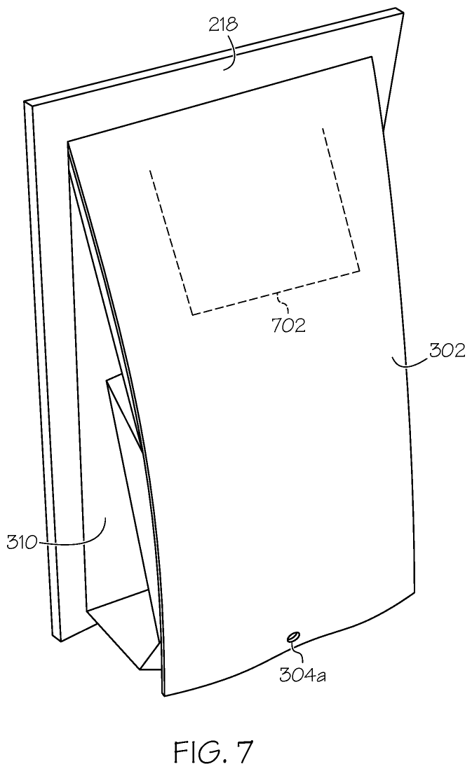

FIG. 7 depict the package door 202 without attachment to the door body 201 in accordance with the principles of the present invention. The frame 218 may have sufficient rigidity to support the receiving bag 310 and/or the cover 302. In this manner, the package door 202 may be installed into an existing front door, such as door 100. In these embodiments, the lower panel 126 may be cut and/or removed, and the package door 202 may be frictionally fit with the remaining perimeter. In addition, the lock 219 may be installed in a position to interact with the door body 201. The receiving back 310 may be in a compressed state, as illustrated in FIG. 7.

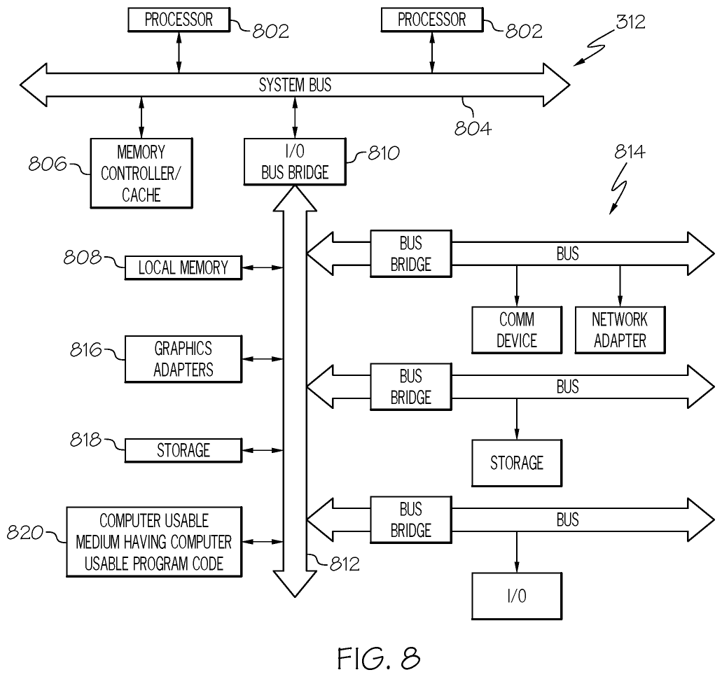

FIG. 8 depicts a block-level diagram of a microprocessor 312 of the package door 202 of FIG. 2 in accordance with the principles of the present invention. The microprocessor 312 may be any device capable of sending and receiving electronic data over an interface. For example, a microprocessor or a computer could be used. The microprocessor 312 may also perform operations on and/or modify the data it receives.

The microprocessor 312 may be embodied as hardware circuits or may be software embodiments wherein program code, such as java, C++, etc., manipulates the hardware of a general purpose hardware circuit. Software embodiments may be implemented as low-level code or even as high level code operating within an operating system, such as Unix, BSD, Microsoft Windows, iOS, etc.

Microprocessor 312 may comprise a processing unit (CPU) 302, local memory 808, peripherals and interfaces, and a general purpose input/output (I/O) interface. The CPU may further comprise local storage. Local storage may be used to store variables, constants, etc. for complex calculations. Local memory may interface with the CPU via a memory interface. The memory interface may allow the CPU to store calculated values, variables, constants, or any other important electronic signal onto the physical local memory. The memory interface may include one or more direct memory access controllers. Of course, part or all of the local memory may be committed to program storage, in which data relevant to the operation of the program is stored. Program storage may also be organized into useful data structures such as a stack or heap. The peripherals and interface and the general purpose I/O interface may interface to external input or output devices. Examples of external input or output devices include any electronic device capable of sending or receiving an electronic signal such as keyboards, mice, printers, scanners, digital sensor, analog sensors, Ethernet, analog to digital converters, ADC, UART, USB etc. Program storage, local memory, peripherals and interface, and general purpose I/O interface may be contained on the circuit board of the CPU. The microprocessor 312 may further comprise a screen whereby the graphics adapter 816 may alter the display, such as at validation or denial of a ticket. In other embodiments, any of these parts may be external to the CPU.

Microprocessor 312 may comprise a symmetric multiprocessor (SMP) system or other configuration including a plurality of processors 802 connected to system bus 804. Alternatively, a single processor 802 may be employed. Also connected to system bus 804 is memory controller/cache 806, which may provide an interface to local memory 808. An I/O bridge 810 may be connected to the system bus 804 and may provide an interface to an I/O bus 814. The I/O bus 812 may be utilized to support one or more buses and corresponding devices, such as bus bridges, input output devices (I/O devices), storage, network adapters, etc. Thus, a network adapter may be coupled to the system to enable the data processing system to become coupled to other data processing systems or remote printers or storage devices through intervening private or public networks.

Also connected to the I/O bus 812 may be devices such as a graphics adapter 816, storage 818 and a computer usable storage medium 820 having computer usable program code embodied thereon. The computer usable program code may be executed, e.g., by the processor(s) to implement any aspect of the present invention, for example, to implement any aspect of any of the methods, processes and/or system components with respect to the present invention. For instance, the computer usable program code can be utilized to implement a linker that implements any one or more of the methods described herein. Moreover, the computer usable program code may be implemented in the local memory 808 or other suitable storage medium.

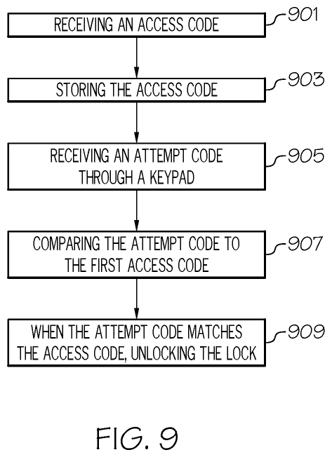

FIG. 9 depicts a block-level diagram of a method of opening the package door 202 of FIG. 2 in accordance with the principles of the present invention. The package door 202 may allow for delivery of a package from a retailer into the purchaser's home without necessarily allowing the delivery person into the home. Thus, the package door 202 may comprise the package door body 216 positioned to allow access through a door body 201 that may be in use as an exterior door to a residence or a business.

A preliminary step may comprise building the package door 202 from a standard door 100. For example, the lower panel 126 of the door 100 may be removed, and the frame 218 may replace the lower panel 126. The frame 218 may be sized to frictionally fit with the lock rail 104, lock stile 108, hinge stile 110, and bottom rail 106. However, the frame 218 may be further secured via attachment by screws, nails, glue, etc.

In some embodiments, the package door 202 may comprise the entire door body 201, as the frame 218 may be built into the door body 201 originally, or even integrally formed with the door body 201.

A customer ordering a package may also be a resident of a residence comprising the package door 202 as an exterior door of the residence. The resident may desire delivery of the package to a safe place inside the residence without allowing the delivery person entry into the residence. When placing an order, the resident may provide delivery instructions, including a code to unlock package door lock 219. Furthermore, the code provided may match a preprogrammed access code stored by the lock 219. Alternatively, the resident may provide the access code to the package door lock 219, such as via keypad or computer interface.

In step 901, the package door lock 219 may receive the access code, such as through the keypad 224 from the resident. In step 903, the access code may be stored. Examples include storing the access code on the package door lock 219 such as by microprocessor 312 storing the access code in memory 808. The microprocessor 312 may also store the lock status of the package door lock 219. For example, the package door lock 219 may default to a locked state. Furthermore, the lock status may default to a locked status.

In step 905, the package door lock 219 may receive an attempt code, such as through the keypad 224 from the delivery person. The microprocessor 312 may receive the attempt code and may further compare the attempt code to the stored access code. When the attempt code matches the access code (e.g. Boolean match), the microprocessor 312 may unlock the package door handle 222. By way of example, the package door handle 222 may have a locked and an unlocked state. The package door handle 222 may default to a locked state, in which the package door tenon 220 is biased to engage the package door mortise 226 but the package door handle 222 may not necessarily be turnable. In alternate embodiments, the locked state may correspond to the package door handle 222 being disengaged from the package door mortise 226 and freely turnable without necessarily withdrawing the package door tenon 200 to open the package door 202. In other embodiments, in the locked state, the package door handle 222 may be turned, but the package door handle 222 is not necessarily engaged in mechanical communication with the package door tenon 220 such that the package door tenon 220 may not necessarily be disengaged from the package door mortise 226 when the package door handle 222 is turned. However, in the unlocked state, the package door handle 222 may be in mechanical communication with the package door tenon 220 such that the package door tenon 220 may be withdrawn from the package door mortise 226 (and into package door body 216 in some embodiments) when the package door handle 222 is turned.

In step 907, the microprocessor 312 may compare the attempt code to the stored access code. The keypad 224 may send the attempt code to the microprocessor 312. In step 909, when the attempt code matches the stored access code, the microprocessor may change the state of the package door lock 219 from locked to unlocked. In some embodiments, the microprocessor may also change the corresponding lock status to unlocked. The delivery person may turn the package door handle 222 to release the package door tenon 220 from the package door mortise 226 and open package door body 216 for placement of the package within receiving bag 310. In some embodiments, when the package door 202 closes, the package door lock 219 may return to a locked state. In these embodiments, the stored lock status may be set to the locked status.

The resident may further remove the package through the access mechanism 402 of the receiving bag 310 without opening the door body 201 or the package door body 216. For example, opening the access mechanism 402 may comprise sliding a slider of a zipper 404, opening the receiving bag flap 406, removing the package, and closing the zipper 404 by moving the slider back to secure the receiving bag flap 406 in the closed position.

Further embodiments include storing a second access code in replacement of the access code such that a second attempt code received through the keypad 224 must match the second access code to unlock the package door lock 219.

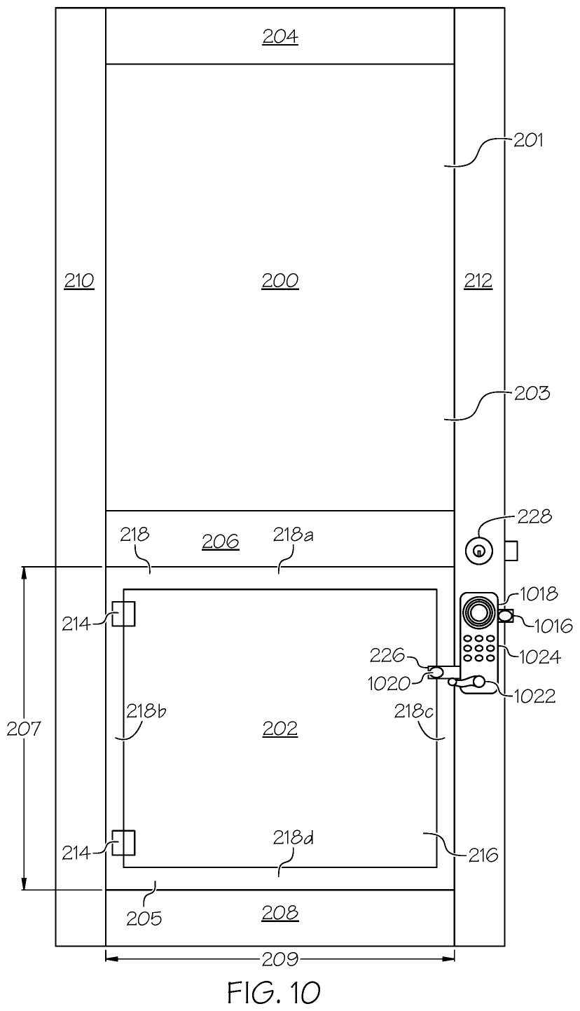

FIG. 10 depicts a diagram of an alternate embodiment of the package door lock according to the principles of the present invention. This alternate embodiment may be referred to a multilock 1018. The multilock 1018 may comprise a residence tenon 1016, a package tenon 1020, a doorknob 1022, a keypad 1024, a microprocessor, and/or a battery.

The multilock doorknob 1022 may comprise a set of states, including a locked state and an unlocked state with respect to the residence tenon 1016 and a locked state and an unlocked state with respect to the package tenon 1020.

The following may apply to the unlocked state of the residence tenon 1016. The residence tenon 1016 may interact with a mortise of a doorframe in an extended position (e.g. closed state), such as doorframe 122 such that the door 200 may remain closed. The residence tenon 1016 may bias to the extended position. The residence tenon 1016 may be withdrawn toward to the mutlilock doorknob 1022 such that the residence tenon 1016 may be disengaged from the doorframe mortise (e.g. into an open position) for opening the door 200.

In the locked state of the residence tenon 1016, the multilock doorknob 1022 may be disengaged from the residence tenon 1016 such that turning the multilock doorknob 1022 may not necessarily disengage residence tenon 1016 from the doorframe mortise. In alternate embodiments, the locked state of residence tenon corresponds to the inability to turn the multilock doorknob 1022 in a direction that would open the door 200.

The following may apply to the unlocked state of the package tenon 1020. The package tenon 1020 may interact with mortise 226, such that the package door 202 may remain closed. The package tenon 1020 may bias to the extended position (closed state). The package tenon 1020 may be withdrawn toward the multilock doorknob 1022 such that the package tenon 1020 may be disengaged from the mortise 226 (e.g. in an open position) for opening package door 202.

In the locked state of the package door tenon 1020, the multilock doorknob 1022 may be disengaged from the package tenon 1020 such that turning the multilock doorknob 1022 may not necessarily disengage package tenon 1020 form the mortise 226. In alternate embodiments, the locked state of package tenon corresponds to the inability to turn the multilock doorknob 1022 in a direction that would open the package door 202.

In some embodiments, the microprocessor may store both sets of states, the residence lock state and the package door lock state as residence lock status and package door lock status, respectively. The residence lock state may be locked by default or set by a lock button on the keypad 1024. The residence lock state may be changed to unlocked when an attempt code is received through the keypad 1024 and the received attempt code matches the stored residence access code. The package lock state may be locked by default. The package lock state may be changed to unlocked when an attempt code is received through the keypad and the attempt code matches the stored package door access code.

When both the residence lock state and the package door lock state are both unlocked, embodiments include turning the doorknob 1022 in a first direction to disengaged the residence tenon 1016 and/or a second direction to disengaged the package door tenon 1020. In some embodiments, the first direction is not the second direction. Embodiments include disengaging only the corresponding tenon when only one lock state is unlocked, regardless of the direction the doorknob 1022 is turned. In these embodiments, turning the doorknob 1022 either direction may disengage the corresponding unlocked tenon when the doorknob 1022 is turned.

Embodiments of the present invention include a door 200 comprising a first door body 201 comprising a major plane, an exterior side, an interior side, and a package door frame 218. The package door frame may be positioned around an opening within the first door body 201 such that a perimeter may be formed around the opening. A second door body, such as the package door body 216, may be in hingeable connection with the package door frame 218. In this manner, the second door body 216 may be receivable into the opening when the second door body 216 is in a closed position, wherein a major plane of the second door body 216 is substantially in the same plane as the major plane of the first door body 201 when the second door body 216 is in the closed position. Furthermore, a handle 222 (e.g. doorknob) comprising a tenon 220 may be positioned to engaged the second door body mortise 226 when the second door body 216 is in a closed position. In these embodiments, the second door body 216 may be held in the closed position, but openable by turning the handle. Furthermore, the tenon 220 may bias to the extended position (e.g. closed position) wherein the tenon 220 biases to engage the mortise 226 when closed such that the door 216 automatically stays closed. In addition, the handle may be configured to disengage the tenon 220 from the mortise 226 of the second door body 216.

The door 200 may further comprise a receiving bag 310 attached to the first door body 201, wherein a perimeter of the attachment of the bag 310 surrounds the opening 211. For example, an opening of the receiving bag 310 may be formed at the perimeter of attachment of the receiving bag 310 to the first door body 201. The opening of the receiving bay 310 may surround the opening of the package receiving door 202 (e.g. the opening that receives the second door body 216). In this manner, the open position of the second door body 216 may allow access to the receiving bag 310 without necessarily allowing access to the interior of a residence.

The door 200 may further comprise a hinge 214 connected to a hinge stile 210 or the package door frame 218 and the hinge 214 connected to the second door body 216, wherein an axis of hingeable rotation is substantially parallel to a length of the first door body 201.

The door 200 may further comprise a lock 219 biased to a locked state, the lock 219 configured to disengage the handle 222 from the tenon 220 when the lock 219 is in the locked state.

The lock 219 may be an electronic lock comprising a keypad 224 in electrical communication with a microprocessor 312. In some embodiments, the lock 219 may be configured to receive an access code and store the access code by the microprocessor 312 (e.g. in the memory 808 of the microprocessor 312 or an offsite memory). The lock 219 may be configured to receive an attempt code through the keypad 224 and compare the attempt code to the stored access code. In these embodiments, the microprocessor 312 may use Boolean logic to match each character and/or numeral of the attempt code entered against the stored access code.

The lock 219 may be configured to switch from the locked state to an unlocked state when the attempt code matches the stored access code. In the unlocked state, turning the handle 222 may withdraw the tenon 220 in mechanical communication with the handle 222 such that the tenon 220 may be withdrawn from the corresponding mortise 226 to open the package door body 216 from the opening. In the locked state, turning the handle 222 may not necessarily open the package door body 216. In some embodiments, the locked state can include disengagement of the handle 222 from the tenon 220, such that the handle 222 is turnable to disengage the tenon 220 from the mortise 226. Embodiments also include disengagement of the tenon 220 from the handle 222 in the locked state.

The receiving bag 310 may further comprise an opening mechanism 402, such as a zipper 404. The receiving bag 310 may further comprise springed hinges that bias the bag 310 to a folded position.

Embodiments of the present invention include a method of securely receiving packages into a residence without allowing entry of the delivery person into the residence. A first access code may be received and stored (e.g. in a memory). The delivery person may enter a first attempt code, such that the keypad 224 may receive the first attempt code. The microprocessor 312 may compare the first attempt code to the first access code, such as by Boolean logic. When the first attempt code matches the first access code, the handle 222 and/or lock 219 may be unlocked or set to the unlocked state. In the unlocked state, turning the handle 222 may disengaging a tenon 220 to allow a receiving door to provide access to a receiving bag 310 (e.g. by opening the package receiving door 202). Then, the delivery person may place the package in the receiving bag 310. The package receiving door 202 may be closed and automatically locked. For example, the Soss hinges may bias to close the package receiving door 202. The delivery person may receive the access code in special delivery instructions provided by the resident upon ordering the package.

The access code may be changed and the second access code stored. In these embodiments, a second attempt code may be received from the delivery person through the keypad 224. When the second attempt code is received after the second access code is stored, the second attempt code must match the second access code in order to unlock the package receiving door, handle, and/or lock.

Further embodiments of the present invention include a door lock for independently regulating access to a residence and a receiving bag 310 of a residence. The door lock 1018 may comprise a handle 1022 in mechanical communication with a first tenon 1016 disposed in a first direction, a second tenon 1020 disposed in second direction that may be opposite the first direction, and a keypad 1024 comprising a memory device. In this manner, the first and the second tenon 1020, 1016 may bias to the extended position (e.g. closed position) for engagement with respective tenons 1020, 1016. Turning the handle 1022 may withdraw the respective unlocked tenon from the corresponding mortise to open the corresponding residence door or package receiving door 202.

The handle 1022 may be attached to a door 200, such as that of a business or residence. The first tenon 1016 may be engageable with a first mortise in a frame of the door when the first tenon 1016 is extended and the second tenon 1020 may be engageable with a second mortise 226 in a body 216 of a receiving door.

The handle 1022 may engage the first tenon 1016 when a first attempt code is received through the keypad 1024 and the first attempt code matches a first access code in the memory 808. The handle 1022 may engage the second tenon 1020 when a second attempt code is received through the keypad 1024 and the second attempt code matches the second access code in the memory 808. In some embodiments, unlocking the handle 1022 with respect to both tenons 1016, 1020 may occur. Turning the handle 1022 in a first direction may engage the first tenon 1016 and turning the handle 1022 in a second direction may engage the second tenon 1020 in these embodiments.

In some embodiments, multilock 1018 may comprise a height and a width. The height may be about 22.86 cm (9 inches). The width may be about 8.255 cm (3.25 inches).

In some embodiments, the package door tenon 220 may comprise a rounded edge such that the second tenon 1020 may be withdrawn sufficiently to close the package door 202 upon the second tenon 1020 hitting a strike plate at the mortise 226. In this manner, the package door 202 may be closed and locked automatically without necessarily requiring re-entry of the code or reengagement of the handle 1022. In fact, the handle 1022 may be disengaged upon opening the package door 202.

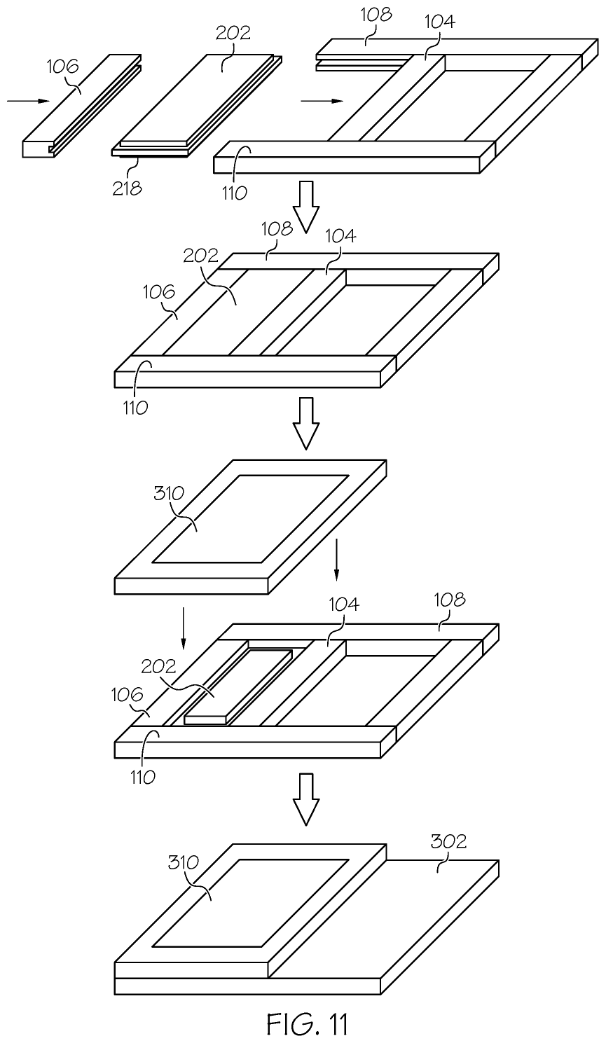

FIG. 11 depicts a block-level diagram of the construction of the package door 202 into an industry standard door 100 in accordance with the principles of the present invention. Generally, entry door widths of about 76.2 cm (30 inches), about 81.28 cm (32 inches), and about 91.44 cm (36 inches) may be considered standard and may be readily available in home improvement and hardware stores. The standard height of an entry door may be about 203.2 cm (80 inches), and the standard thickness may be about 4.45 (1.75 inches). Because they are adjacent to the outside, entry doors may be a bit thicker than their interior counterparts to provide additional insulation.

As illustrated, the package door 202 may be fit into the door body 102, by sliding the frame 218 and package door 202 between lock stile 108 and hinge stile 110 and against lock rail 104. Bottom rail 106 may also be inserted and butted against the frame 218. In the next step, the receiving bag 301 may be placed around the package door 202 at the interior side of the package door 202. The cover 302 may also be attached as previously described.

Residential doors may have industry standard sizing. In order for the package receiving door 202 to fit between the lock rail 104, the bottom rail 106, the lock stile 108 and the hinge style 110, the sizing of the package door 202 with the frame 218 may be as follows with respect to height×width: For a residential door of 203.2 cm×76.2 cm (80″×30″), the frame 218 may be about 73.6 cm×50.8 cm (29″×20″) and the opening of the receiving bag 310 may be about 96.5 cm×55.8 cm (38″×22″). For a residential door of 203.2 cm×82.28 cm (80″×32″), the frame 218 may be about 76.2 cm×55.8 cm (30″×22″) and the opening of the receiving bag 310 may be about 96.5 cm×60.9 cm (38″×24″). For a residential door of 203.2 cm×91.44 cm (80″×36″), the frame 218 may be about 78.7 cm×66.0 cm (31″×26″) and the opening of the receiving bag 310 may be about 96.5 cm×66.0 cm (38″×26″). For a residential door of 207.6 cm×95.2 cm (81.75″×37.5″), the frame 218 may be about 81.3 cm×68.6 cm (32″×27″) and the opening of the receiving bag 310 may be about 99.0 cm×66.0 cm (39″×26″). For a residential door of 208.9 cm×97.1 cm (82.25″×38.25″), the frame 218 may be about 83.8 cm×71.1 cm (33″×28″) and the opening of the receiving bag 310 may be about 101.6 cm×68.6 cm (40″×27″).

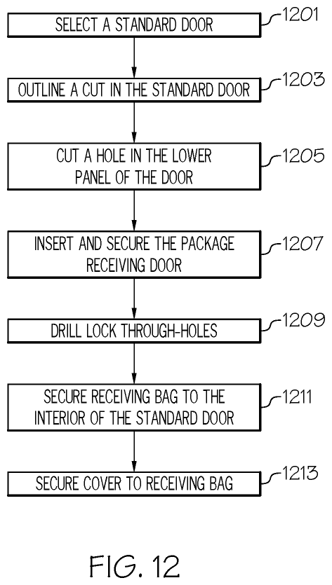

FIG. 12 illustrates a block diagram of a method of installation of the package door 202 into a standard door in accordance with the principles of the present invention. In some embodiments, the package door 202 may be sold as a kit for retrofitting a standard door. In step 1201, a standard door may be selected for addition of the package door 202. In step 1203, the cut for the package door 202 may be outlined. For example, the sizes above may be used as a guide. Thus, the lock stile, hinge stile, bottom rail, and lock rail may be marked. In some embodiments, the cut may be sized within the lower panel without reaching the rails and stiles. In step 1205, the hoe may be cut into the lower panel of the door, such as with a saw having a wood-cutting or metal-cutting blade, or other appropriate tool. In step 1207, the package-receiving door may be fit within the new cut. For example, the frame 218 may be frictionally engaged with the new cut. Furthermore, glue, nails, screws, or any other secure attachment mechanism may be used to secure the frame 218 within the standard door. In step 1209, through-holes may be drilled to fit the lock 218. A first hole may be necessary through the thickness of the door to accommodate the lock 218. A second hole may be drilled from the edge of the new cut into the first through-hole to accommodate the lock tenon to enter a mortise of the package door 202. In step 1211, the receiving bag 310 may be secured to the interior side of the standard door. As described herein, the opening of the receiving bag 310 may be attached around the opening of the package door 202, such as in the corresponding size set forth above. This attachment may be by glue, nails, screws, etc. In some embodiments, step 1213 may comprise securing the cover 302 to the receiving bag 310. This attachment may be by sewing, hook and loop, snaps, glue, etc. However, embodiments may include the receiving bag 310 already secured to the cover 302. The resulting retrofitted standard door may be substantially similar to the door 200 of FIG. 2.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A door, comprising:
a first door body comprising a major plane, an exterior side, an interior side, and a package door frame positioned around an opening within the first door body;
a package receiving door comprising a second door body in hingeable connection with the package door frame, the second door body receivable into the opening when the second door body is in a closed position, wherein a major plane of the second door body is substantially in the same plane as the major plane of the first door body when the second door body is in the closed position;
a handle comprising a tenon positioned to engaged the second door body mortise when the second door body is in a closed position;
wherein the handle is configured to disengage the tenon from the mortise of the second door body.

2. The door of claim 1, further comprising:
a receiving bag attached to the first door body, wherein a perimeter of the attachment of the bag surrounds the opening.

3. The door of claim 1, further comprising:
a hinge connected to a hinge stile of the package door frame and the hinge connected to the second door body,
wherein an axis of hingeable rotation is substantially parallel to a length of the first door body.

4. The door of claim 1, further comprising:
the tenon biased to a closed state, and
a lock comprising the handle, the lock biased to a locked state.

5. The door of claim 4,
wherein the lock further comprises an electronic lock comprising a keypad in electrical communication with a microprocessor;
wherein the lock is configured to receive an access code and store the access code by the microprocessor;
wherein the lock is configured to receive an attempt code through the keypad and compare the attempt code to the stored access code; and
wherein the lock is configured to switch from the locked state to an unlocked state when the attempt code matches the stored access code.

6. The door of claim 4,
wherein the locked state comprises disengagement of the handle from the tenon, such that the handle is turnable to disengage the tenon from the mortise.

7. The door of claim 4,
wherein the locked state comprises disengagement of the tenon from the handle.

8. The door of claim 2, wherein the receiving bag further comprises an opening mechanism.

9. The door of claim 2, wherein the receiving bag further comprises springed hinges that bias the bag to a folded position.

10. A method of securely receiving packages, comprising:
receiving a first access code;
storing the first access code in a memory of a door lock comprising a microprocessor comprising the memory and a receiving door tenon biased to a closed position for engagement of a mortise of a package receiving door positioned in an exterior door;
receiving a first attempt code through a keypad in electrical communication with the microprocessor;
comparing the first attempt code to the first access code;
when the first attempt code matches the first access code, setting the lock state of the handle to unlocked;
when the unlocked handle is turned, disengaging a tenon to allow a receiving door to provide access to a receiving bag;
receiving a package into the receiving bag connected with the frame of the receiving door.

11. The method of claim 10, further comprising:
receiving a second access code;
receiving a second attempt code through the keypad;
when the second attempt code matches the second access code.

12. The method of claim 10, further comprising:
setting the lock state of the handle to locked upon closing the receiving door.

13. The method of claim 10, wherein the first access code is received through the keypad.

14. The method of claim 10, wherein the first access code is stored in the memory of the keypad.

15. A door lock for independently regulating access to a residence and a receiving bag of a residence, the door lock comprising:
a handle connected with a first tenon and a second tenon;
the first tenon disposed in a first direction comprising a closed position when extended and an open position when withdrawn;
the second tenon disposed in a second direction comprising a closed position when extended and an open position when withdrawn;
a keypad in electrical communication with a microprocessor comprising a memory, the microprocessor configured to store a first access code and a second access code;
wherein the handle is mechanically engageable to move the first tenon from the closed position to the open position when an attempt code matches the stored first access code, and
wherein the handle is mechanically engageable to move the second tenon from the closed position to the open position when an attempt code matches the stored second access code.

16. The door lock of claim 15, wherein the handle is connected to a door, the first tenon is engageable with a first mortise in a frame of the door when the first tenon is extended into the closed position, and the second tenon is engageable with a second mortise in a body of a receiving door when the second tenon is extended into the closed position.

17. The door lock of claim 16, wherein the first lock state is unlocked when a first attempt code is received through the keypad and the first attempt code matches a first access code in the memory.

18. The door lock of claim 16, wherein second lock state is unlocked when a second attempt code is received through the keypad and the second attempt code matches the second access code in the memory.

19. The door lock of claim 16, wherein the first direction is not the same direction as the second direction.

20. The door lock of claim 19, wherein the first tenon and the second tenon bias to the closed position.
